(19) United States
(12) Patent Application Publication
(10) Pub. No.: US 2016/0150350 A1
(43) Pub. Date: May 26, 2016

(54) METHOD AND APPARATUS FOR PAIRING A WEARABLE DEVICE AND A SMART DEVICE

(71) Applicant: Samsung Electronics Co., Ltd., Suwon-si (KR)

(72) Inventors: Mangesh Abhimanyu INGALE, Yongin-si (KR); Vijaya Kumar TUKKA, Yongin-si (KR); Jaehyuk JANG, Suwon-si (KR); Diwakar SHARMA, Bangalore (IN)

(21) Appl. No.: 14/950,622

(22) Filed: Nov. 24, 2015

(30) Foreign Application Priority Data
Nov. 26, 2014 (IN) 1243/KOL/2014

(51) Int. Cl. H04W 4/00; H04W 12/08; H04L 29/06; H04L 12/28; H04L 29/08

(52) U.S. Cl. CPC H04W 4/006; H04L 12/2809; H04L 67/125; H04L 63/0876; H04W 12/08

(57) ABSTRACT

The present disclosure relates to a communication method and system for converging a 5th-Generation (5G) communication system for supporting higher data rates beyond a 4th-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. A method of an electronic device for communicating with another electronic device is provided. The method includes capturing user identity metrics of a user, and determining, by a processor of the electronic device, that the user is an authorized user based on a result of a comparison between the identified user identity metrics and association information.

### CROSS-REFERENCE TO RELATED APPLICATION(S)

This application claims benefits under 35 U.S.C. §119(a) of an Indian Provisional application filed on Nov. 26, 2014 in the Indian Intellectual Property Office and assigned Serial number 1243/KOL/2014, the entire disclosure of which is hereby incorporated by reference.

### TECHNICAL FIELD

The present disclosure relates to Internet of things (IoT) related applications and use case scenarios. More particularly, the present disclosure relates to automatic association/disassociation of an IoT device with another smart device based on user identification. Further, smart triggering of cellular radio for mobile initiated calls by the IoT device is envisaged based on trigger metric detection.

### BACKGROUND

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

Internet of things (IoT) is envisioned where wireless connectivity is expected to be native to devices which would connect directly to other devices in proximity (e.g., a Bluetooth connection, a Wi-Fi connection, a Zigbee connection etc.) or would connect to application servers with a cellular link (e.g., a second generation (2G) global system for mobile communications (GSM)/code division multiple access (CDMA) connection, a third generation (3G) universal mobile telecommunications system (UMTS) connection, a fourth generation (4G) long term evolution (LTE)/worldwide interoperability for microwave access (WiMAX) connection, etc.) or through a local hub (e.g., a hub having cellular radio capability or digital subscriber line (DSL) connectivity).

IoT technology is commercially available in many home appliances providing users the so called smart home experience. IoT is also referred as machine-to-machine (M2M) or machine type communication (MTC). IoT deployments are already picking up in metering applications for periodic reports about usage of electricity, water, gas, etc. to utility provider's application servers. This automation is not only convenient to a utility provider for avoiding manual meter readings but also would help users to control utility bills and contribute towards energy conservation through smartphone applications communicating with smart meters.

IoT is also expected to take its position in the automobile industry where users would benefit from extending the smart home environment to the smart car environment, such that a user's smart device connects to an electronic console/dashboard inside the automobile. Smartphones and tablets are commonplace and technologies are extending towards wearable devices such as smart watches, health monitoring bands, smart glasses etc. Wearable devices are equipped with widely available sensors that are currently in smartphones, such as accelerometers, gyroscopes, cameras, fingerprint scanners, etc., and in addition health monitoring sensors for heart rate, blood pressure etc. Wearable devices are equipped with radios for proximity connectivity such Bluetooth, Wi-Fi, near field communication (NFC), Zigbee, etc., as well as cellular connectivity using 2G/3G/4G radios based on GSM, CDMA, UMTS, WiMAX and LTE.

The IoT device referred above is not restricted to wearable devices like smart watches, but could also cover health bands, kid-care or childcare monitoring bands, eldercare bands, smart glasses, smart necklaces, electronic consoles/dashboards inside automobiles etc., including widely known IoT devices for metering, in smart homes for thermostat control and home appliances. Even though the present disclosure is illustrated in detail referring to wearable kind of IoT device, the scope of the present disclosure is equally applicable for various categories of IoT devices citing a few examples as mentioned above. The description of the present disclosure referring to the wearable IoT device should not be considered as limiting for the applicability of the present disclosure.

Provided below are the following issues regarding the operation of an IoT device.

First, for proximity connectivity the existing manual/NFC based procedure for association/disassociation (pairing/un-pairing) of the IoT device with a smart device is inadequate to address privacy concerns, if the IoT device is a shared device.

Second, regardless of whether the IoT device is shared or not, the existing manual/NFC based procedure for association/disassociation (pairing/un-pairing) of the IoT device with a smart device is not user friendly. The existing manual/NFC based procedure for association/disassociation (pairing/un-pairing) of the IoT device with multiple smart devices is cumbersome and it needs to be manually tracked for multi-device connectivity of the same user.

Third, for IoT devices having cellular radio capability (e.g., second generation (2G)/third generation (3G)/fourth generation (4G)) the radio capability is disabled when an IoT device is in proximity of associated (paired) smart device. Currently, activating the radio capability of an IoT device is typically triggered based on losing the proximity connectivity with associated (paired) smart device. This is inadequate to address several use cases of an IoT device when applied to childcare monitoring and notification, eldercare alerts and tracking unauthorized usage of the IoT device which cannot be useful for theft detection and tracking.

Finally, in a multi-device connectivity scenario, especially in a smart home environment, there is a need to associate (pair) the IoT device to the nearest smart device of the user. This could be helpful to not only save battery of the IoT device but also provide seamless service enhancing the user experience. With existing procedures this is not possible to achieve in a user friendly manner and without user intervention (i.e., manually).

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an automatic association/disassociation (pairing/un-pairing) procedure for an Internet of things (IoT) device (e.g., a wearable smart watch) to pair with a smart device (e.g., a smartphone) is proposed based on user identification. The procedure is made user friendly by creating an association context based on which pre-defined actions are taken by the IoT device.

Another aspect of the present disclosure is to provide a shared wearable (IoT) device. In smart home environment based on user identification, the shared wearable (IoT) device associates with the smart device corresponding to the user using the wearable and in accordance to pre-defined or pre-configured association context. In smart car environment based on user identification, the shared car console/dashboard (e.g., the IoT device) associates with the smart device (e.g., a smartphone or a smart watch) corresponding to the user currently occupying the driver seat and in accordance to pre-defined or pre-configured association context. In a smart small office or a smart school environment based on user identification, the shared IoT device associates the private settings of user to activate the shared resources and upon detection of another user in proximity the private settings are de-activated and public settings are activated.

Another aspect of the present disclosure is to provide a wearable (IoT) device with a nearest smart device of the user based on displacement detection which triggers automatic association/disassociation procedure.

Another aspect of the present disclosure is to provide triggers for turning a cellular radio ON or triggers for a mobile initiated notification when the wearable (IoT) device is not associated (paired) with a smart device or when in standby mode to address emergency situations notifying an incident.

Another aspect of the present disclosure is to provide theft detection and tracking based on user identification and then disabling the automatic association/disassociation functionality in the wearable (IoT) device and notifying the owner by triggering cellular radio ON or triggering the mobile initiated notification.

In accordance with an aspect of the present disclosure, an electronic device in a wireless communication system is provided. The electronic device includes one or more sensor units electrically coupled with a processor and configured to identify user identity metrics of a user, a radio frequency (RF) unit electrically coupled with the processor and configured to perform communication with another electronic device, and to pair with the other electronic device or un-pair from the other electronic device, a memory unit electrically coupled with the processor and configured to store association information, and the processor configured to control the one or more sensor units to identify the user identity metrics, to identify the user based on the association information and the user identity metrics, and to determine that the user is an authorized user based on a result of a comparison between the identified user identity metrics and the stored association information.

In accordance with another aspect of the present disclosure, a method of an electronic device for communicating with another electronic device is provided. The method includes capturing user identity metrics of a user and determining, by a processor of the electronic device, that the user is an authorized user based on a result of a comparison between the identified user identity metrics and association information.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates manual association and disassociation (pairing and unpairing) between an Internet of things (IoT) device and a smart device according to an embodiment of the present disclosure;

FIG. 2 illustrates a concept of an association context according to an embodiment of the present disclosure;

FIG. 3 illustrates a procedure for automatic association (pairing) according to an embodiment of the present disclosure;

FIG. 4 illustrates a shared device scenario between authorized users according to an embodiment of the present disclosure;

FIG. 5 illustrates an automatic association procedure for a shared device scenario according to an embodiment of the present disclosure;

FIG. 6 illustrates smart pairing to multiple devices in a smart home environment according to an embodiment of the present disclosure;

FIG. 7 illustrates a procedure to connect to a nearest smart device in a home environment according to an embodiment of the present disclosure;

FIG. 8 illustrates automatic triggering of a cellular radio communication capability of an IoT device according to an embodiment of the present disclosure;

FIG. 9 illustrates a general procedure for sending an alert notification to an authorized user according to an embodiment of the present disclosure;

FIG. 10 illustrates a specific procedure for sending an alert notification to an authorized user according to an embodiment of the present disclosure; and

FIG. 11 is a block diagram of a wearable device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

While expressions including ordinal numbers, such as “first” and “second,” as used herein may modify various constituent elements, such constituent elements are not limited by the above expressions. For example, the above expressions do not limit the sequence and/or importance of the corresponding constituent elements. The above expressions may be used merely for the purpose of distinguishing a constituent element from other constituent elements. For example, a first user device and a second user device indicate different user devices although both are user devices. For example, a first constituent element may be termed a second constituent element, and likewise a second constituent element may also be termed a first constituent element without departing from the scope of embodiments of the present disclosure.

When a component is referred to as being “connected to” or “accessed by” any other component, the component may be directly connected to or accessed by the other component, but another new component may also be interposed between them. By contrast, when a component is referred to as being “directly connected to” or “directly accessed by” any other component, there is no new component between the component and the other component.

Unless defined otherwise, all terms used herein, including technical terms and scientific terms, have the same meaning as commonly understood by a person of ordinary skill in the art to which the present disclosure pertains. Such terms as those defined in a generally used dictionary are to be interpreted to have the meanings equal to the contextual meanings in the relevant field of art, and are not to be interpreted to have ideal or excessively formal meanings unless clearly defined herein.

An electronic device according to various embodiments of the present disclosure may be a device including a communication function. For example, the electronic device may include at least one of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), a motion picture experts group (MPEG) audio layer 3 (MP3) player, a mobile medical appliance, a camera, and a wearable device (e.g., a head-mounted-device (HMD), such as electronic glasses, electronic clothes, an electronic bracelet, an electronic necklace, an electronic appcessory, electronic tattoos, or a smartwatch).

According to various embodiments of the present disclosure, the electronic device may be a smart home appliance with a communication function. The smart home appliance as the electronic device, for example, may include at least one of a television (TV), a digital versatile disc (DVD) player, an audio, a refrigerator, an air conditioner, a vacuum cleaner, an oven, a microwave oven, a washing machine, an air cleaner, a set-top box, a TV box (e.g., Samsung HOMESYNC™, APPLE TV™, or GOOGLE TV™), a game console, an electronic dictionary, an electronic key, a camcorder, and an electronic photo frame.

According to various embodiments of the present disclosure, the electronic device may include at least one of various medical devices (e.g., magnetic resonance angiography (MRA), magnetic resonance imaging (MRI), computed tomography (CT), and ultrasonic machines), navigation equipment, a global positioning system (GPS) receiver, an event data recorder (EDR), a flight data recorder (FDR), an automotive infotainment device, electronic equipment for ships (e.g., ship navigation equipment and a gyrocompass), avionics equipment, security equipment, a vehicle head unit, an industrial or home robot, an automatic teller machine (ATM) of a banking system, and a point of sales (POS) in a shop.

According to various embodiments of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter).

The electronic device according to various embodiments of the present disclosure may be a combination of one or more of the aforementioned various devices. Further, the electronic device according to various embodiments of the present disclosure may be a flexible device. Further, the electronic device according to various embodiments of the present disclosure is not limited to the aforementioned devices.

Hereinafter, an electronic device according to various embodiments of the present disclosure is described with reference to the accompanying drawings. Herein, the term “user” may refer to any person who uses an electronic device or any other device (e.g., an artificial intelligence electronic device) using an electronic device.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Further, the detailed description of various embodiments of the present disclosure is made mainly based on wearable device, but the subject matter of the present disclosure can be applied to other device having a similar technical background and channel form after a little modification without departing from the scope of the present disclosure, and the above can be determined by those skilled in the art.

In personal communication space wearables (e.g., Internet of things (IoT) devices) having proximity connectivity capability are associated (paired) with smart devices like smartphones, tablets etc. of the user either manually or using the near field communication (NFC) interface. The same procedure is done for disassociation (un-pairing) of the smartphones from the wearable device. Further, it is also possible to associate (pair) multiple smart devices like smartphones and tablets of the user with the wearable device.

However, the existing pairing/un-pairing is based on a manual procedure or an NFC enabled procedure, which is quite inconvenient in the context of a scenario where the wearable device will be shared by more than one user. The term shared wearable (shared IoT device) means the owner or primary user of the wearable (device) would share the device with other authorized users. For example, in home it is possible that the wearable is shared between husband and wife (in this case husband may be the primary user and the wife is an authorized user with whom the wearable is shared) such that the manual association/disassociation needs to be done every time the concerned user is using the wearable and pairs with his/her corresponding smart device. It is possible that the shared wearable was paired with smart device of user #1, and user #1 removes the wearable but forgets to manually un-pair from his/her smart device. The wearable is then used by user #2 (user #2 is also an authorized user) but the wearable still remains paired with the smart device of user #1 (provided it is in proximity of the shared wearable).

With the existing procedure it is quite possible that user #2 receives a notification on the wearable from the paired smart device of user #1. This deteriorates the privacy of the user in the shared environment. So, there is a need to enhance existing association/disassociation procedures, such that the wearable is able to first identify the user and after user identification of the user, the wearable is able to perform an automatic procedure to associate with the concerned user's smart device currently using the wearable and disassociate from the smart device of the previous user.

The shared usage scenario for automatic association/disassociation is not limited within the scope of wearable devices (e.g., a smart watch) and a smart device (e.g., a smartphone) in a home environment, but is also equally applicable in a smart car environment. A smart car is normally shared by the family and passengers in the car, other than the one who is in driver seat, can fully enjoy the smart car environment in terms of connectivity, entertainment, music etc. (assuming the driver is not distracted with entertainment videos, but the driver can send verbal commands and receive audio notifications for messages or navigation through the car console/dashboard). So, the car's console/dashboard will be shared by family members such that the corresponding smart device (smartphone or smart watch) of the concerned family member is associated with the car's console/dashboard.

In the smart car environment, the car console/dashboard is the shared IoT device having proximity connectivity and/or cellular radio capability. For example, when a husband is in the driver seat; it would be required that he would like to associate his smart phone with the car's console/dashboard to receive notification of messages (e.g., short message service (SMS) and electronic mail (e-mail)) on the console/dashboard (notification messages may be converted to audio messages by the car's console/dashboard) while he can still concentrate on the driving because there is no need for the driver to look at the console display.

Another example is when the husband is driving the shared car then the environment inside the car is automatically set according to his choice and taste like the music directory is set for his favorite songs, the car air fresheners or the car perfume is according to his taste or the lighting inside the car is set according to his choice. In short, the car ambience is set according to the person who is in the driver's seat when the car is a shared entity. This is taken care by the association context which resides inside the car console/dashboard and it is able to identify the person in the driver's seat. In yet another example, if it is a long drive then the wife may occupy the driver's seat in which case her smartphone now needs to be associated with the car's console/dashboard for notifications received on her smartphone while driving which can be converted to audio messages by the car console/dashboard.

Here we consider the car console/dashboard as an IoT device which may be typically equipped with several sensors, navigation capability, proximity connectivity, cellular radio capability and the usual audio/video control and the display unit. With existing manual procedure it is quite possible that driver #2 (wife who is currently occupying the driver seat) receives a notification on the car console/dashboard from the paired smart device (e.g., smartphone) of driver #1 (husband who is resting after couple of hours of driving and assuming he has not manually unpaired his smartphone). This leads to not only exposing of the privacy of the user (husband in this example) but also driver inconvenience assuming manually pairing in the shared car environment.

Accordingly, there is a need to enhance existing association/disassociation procedures such that the car console/dashboard is able to first identify the user occupying the driver seat and after user identification the car console/dashboard performs automatic procedure to associate with the concerned driver's smart device (e.g., smartphone or smart watch) currently occupying the driver seat. The shared usage could also be extended to further use cases like small office environment or school environment or smart hotel environment where a team of employees (students) or hotel guests would need to associate their respective smart device with IoT device depending on the usage scenario. Automatic association/disassociation (pairing/un-pairing) based on user identification would definitely enhance the user experience.

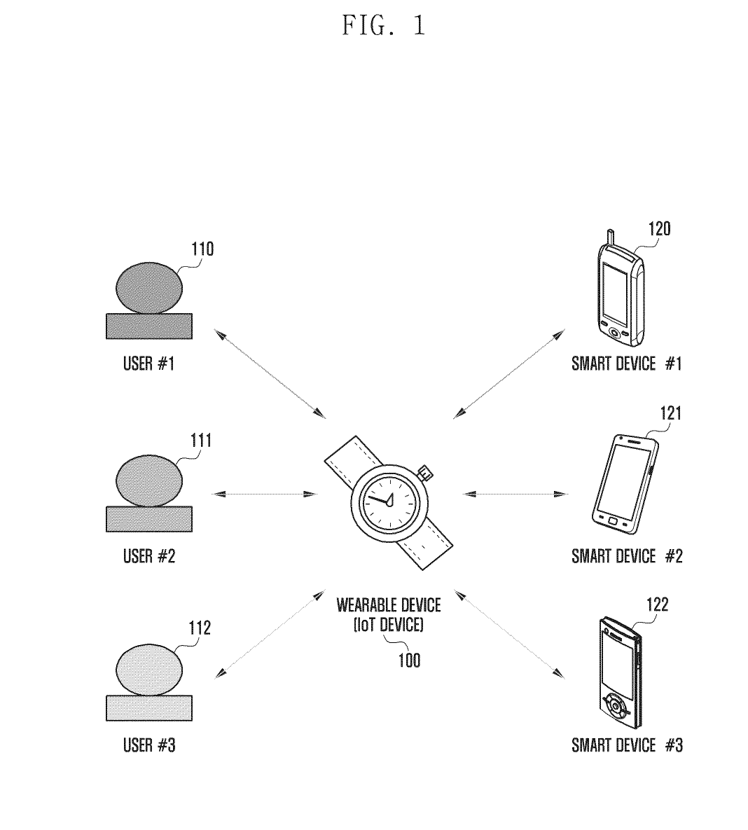

FIGS. 1 through 11, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

### Manual Association/Disassociation (Pairing/Un-Pairing)

FIG. 1 illustrates manual association and disassociation (pairing and un-pairing) between an IoT device and a smart device according to an embodiment of the present disclosure.

Referring to FIG. 1, an IoT device 100 is illustrated, where the IoT device 100 (e.g., a wearable device) can be associated with smart device #1 120 corresponding to user #1 110 using a manual procedure, which in one example may be based on an existing Bluetooth based connection set-up and pairing. When the Bluetooth interface in the IoT device 100 and smart device #1 120 is activated, then the IoT device 100 will send a discovery signal for Bluetooth devices in the proximity thereof, and on detecting the Bluetooth activated device, an association protocol between the IoT device 100 and smart device #1 120 is used to establish the connectivity. This establishment of the association/connectivity between two devices based on Bluetooth is called pairing. After pairing the devices, the two associated devices are allowed to transfer data using Bluetooth interface for any application specific exchange.

In another implementation the association could be based on an NFC protocol, such that when the IoT device 100 having a passive NFC chip and smart device #1 120 enabled with active NFC chip come in physical contact data can be transferred from the smart device #1 120 to the IoT device 100. On the other hand the NFC based protocol can be leveraged to bootstrap the Bluetooth interface for pairing the IoT device 100 with smart device #1 120 when the two devices touch each other. As Bluetooth based association (pairing) remains intact as long as the two paired devices are in close proximity (a few meters). When the paired devices are out of range then the connectivity is lost. Un-pairing the two devices need to manually remove the bond between the two devices.

However, using this existing procedure either manually triggered by enabling Bluetooth or by bootstrapping Bluetooth with NFC does not establish an association context. Association context means the smart device identity (e.g., name of a smart device i.e., smart device #1 120, smart device #2 121, smart device #3 122 so on and so forth) is associated with an authorized user (e.g., user #1 110, user #2 111, user #3 112, respectively) of the device based on user credential such as user identity metric. Bluetooth pairing just creates association between the devices and not an association context which would tag the smart device (e.g., smartphone) to its authorised user and his credentials such as user identity metric.

As illustrated in FIG. 1, if the IoT device 100 is a shared device used by more than one authorized user (e.g., user #1 110, user #2 111, user #3 112 so on and so forth) then the existing association/disassociation does not take user identity into account and it is vulnerable to privacy encroachment. Further, this existing manual procedure works fine but could be further enhanced with user identification and based on association context which would automate the procedure and may eliminate the concern of privacy encroachment.

### Association Context

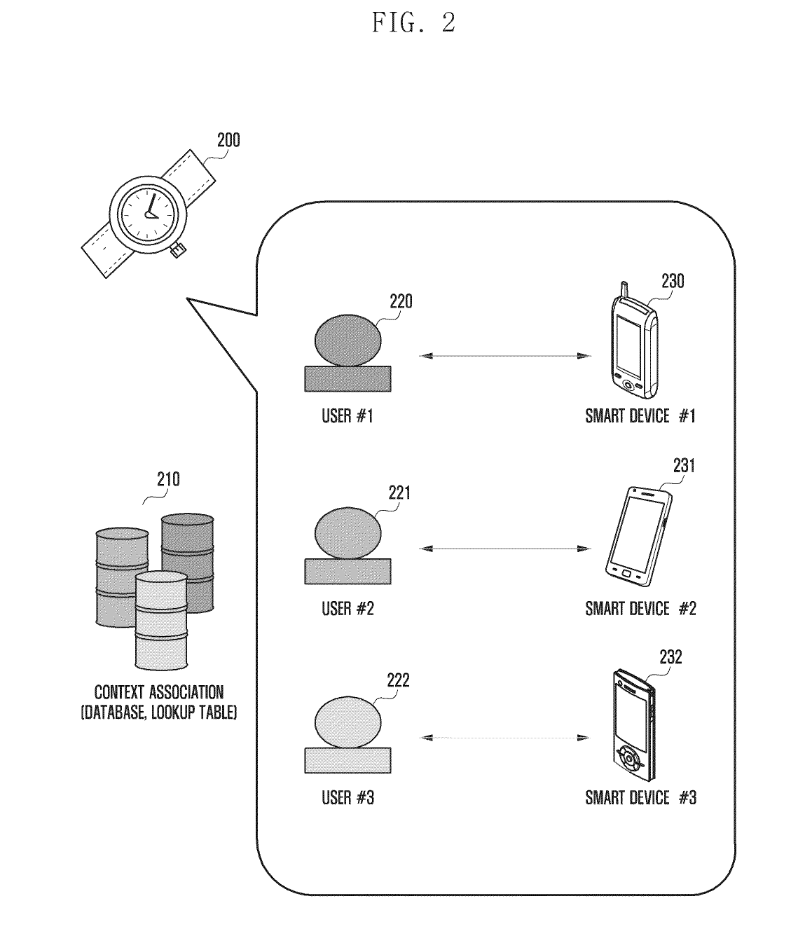

FIG. 2 illustrates a concept of an association context according to an embodiment of the present disclosure.

Referring to FIG. 2, a concept of creating an association context 210 is illustrated, where this concept can be based on using a database or look-up table to store the association context 210, where a unique user identity is tagged with a smart device (e.g., a smartphone) identity as an attribute for authorized usage of a shared wearable 200 (e.g., a smart watch which is an IoT device).

The unique user identity is based on a user identity metric which needs to be input (configured) in the wearable 200 through on board sensors to create the association context 210 using an application running on the wearable 200. In a case of a shared smart car, the association context 210 resides in the car console or dashboard comprising the user identity metric input through on board sensors in the car and/or car console. In this case the car console or dashboard is the wearable 200 (e.g., the IoT device), as illustrated in FIG. 2.

According to an embodiment of the present disclosure, the simplest form of association context 210 is a list of unique user identity metrics for a plurality of authorized users of the shared wearable 200 (e.g., the IoT device).

According to an embodiment of the present disclosure, a user identity metric is at least one of a finger print of the authorized user, an image of a face of the authorized user, an eye iris/retina of the authorized user, any biological parameter such as heart rate/blood flow rate/blood pressure of the authorized user, and the length of the strap of the wearable based on thickness of the wrist of the authorized user.

According to an embodiment of the present disclosure, the user identity metric could be a combination of independent identity metrics. For example the length of the strap of the wearable 200, when user #1 220 wears the wearable 200, is combined with the finger print or the eye iris/retina of user #1 220 to strengthen the uniqueness of the user identity metric.

According to an embodiment of the present disclosure, the association context 210 can be enriched by tagging the unique user identity metric with several attributes. One example of such attribute is the name of the smart devices (e.g., smart device #1 230 which may be a smartphone or tablet) belonging to that authorized user (i.e., user #1 220). Another attribute could be protected storage space in the wearable 200 such that when data is transfer to the wearable 200 after user identification using the association context 210 of user #1 220 from the smart device #1 230, the data is stored in a pre-defined folder of that user (i.e., user #1 220 which is protected).

A further attribute could be auto sign-in/sign-out for social networking applications of the user such as KakaoTalk, Facebook, etc. running on the wearable 200 which would protect the incoming notifications to the wearable 200 when wearable is shared with another authorized user. This means when wearable 200 is used by user #1 220 then it would be automatically paired with smart device #1 230 based on the association context 210 residing in the wearable 200 which identifies user #1 220 based on the user identity metric and associates with the smart device #1 230 which is an attribute and also activates the social network application associated with user #1 220 in the wearable 200. If the shared wearable 200 is used by user #2 221 then the association context 210 residing in the wearable 200 would first identify user #2 221 based on the user identity metric. The wearable 200 then automatically un-pairs with smart device #1 230, signs-out of the social networking applications running on the wearable 200 associated with user #1 220 and automatically pairs with smart device #2 231 activating the social networking applications associated with user #2 221. In a case of a shared smart car, the attributes of the association context 210 can be list of audio/video files, air freshener or car perfume settings, inside car lighting settings or driver seat adjustment settings so on and so forth.

It is possible to tag the unique user identity metric with multiple devices belonging to that user. There are many ways through which the association context 210 of an authorized user can be enriched for filtering data, notifications, etc., associated with application used by that particular user so that it could be protected from privacy encroachment especially in a shared wearable (IoT device) scenario such as smart home environment or the smart car environment.

The association context concept is illustrated in FIG. 2, such that the wearable 200 maintains a database or look-up table of the unique identity metric tagged with one or more attributes associated with the authorized user. The underlying assumption for creating such association context 210 is that the wearable 200 (e.g., the IoT device) is equipped with appropriate sensors to collect the unique identity metric of the authorized user through an application program running on the wearable 200. The corresponding sensor on board the wearable 200 remains activated for user identification to further trigger the automatic association/disassociation procedure proposed in the present disclosure. In case the wearable 200 is wearable, the sensors are placed on board of the wearable. In case the IoT device is car console or car dashboard the sensors like finger print detection sensor or the camera is placed on the steering of the car or some other convenient location inside the car.

The association context 210 may also include a primary user or master user of the wearable 200 (e.g., the IoT device). The primary user could be the owner of the wearable 200 (e.g., the IoT device) or it could be someone who needs to be notified of certain situations and incident if an alert is triggered (e.g., in case of unauthorized usage or use cases like childcare/kid-care/eldercare etc.).

According to an embodiment of the present disclosure, the association context 210 has an entry for primary user or master user of the IoT device who would be notified in certain situation if an alert is triggered for handling emergency situations.

According to an embodiment of the present disclosure, the association context 210 can be stored in a server which can be fetched by the shared wearable to authorize the user for the usage of the wearable 200 and automatically associate/disassociate with a user's (e.g., user #3 222) smart device (e.g., smart device #3 232) which is one of the attribute of the association context 210. Additionally, the association context 210 can be created by transferring the association context 210 from a user's smart device (e.g., a smartphone) to a shared wearable device (e.g., a smartwatch). It is also possible to create a shared or public association context especially in a family environment where some information could be open information or public information which is not subject to privacy concerns.

Such shared association context 210 could be open to all authorized users or a pre-configured set of authorized users of the wearable 200 (IoT device). In the case of shared smart car when the entire family is travelling in the car then the shared association context 210 is activated so that audio/video files settings and the car ambience setting is suitable for the entire family which is not subject to privacy concerns unlike the case when the car is exclusively used by either husband or wife where the association context 210 needs to take care of privacy encroachment. Similarly, in a smart home environment certain applications in wearable device 200 are available for multiple authorized users (e.g., applications for smart home need to be usable for both authorized users, i.e., a husband and a wife).

### Automatic Association/Pairing Procedure

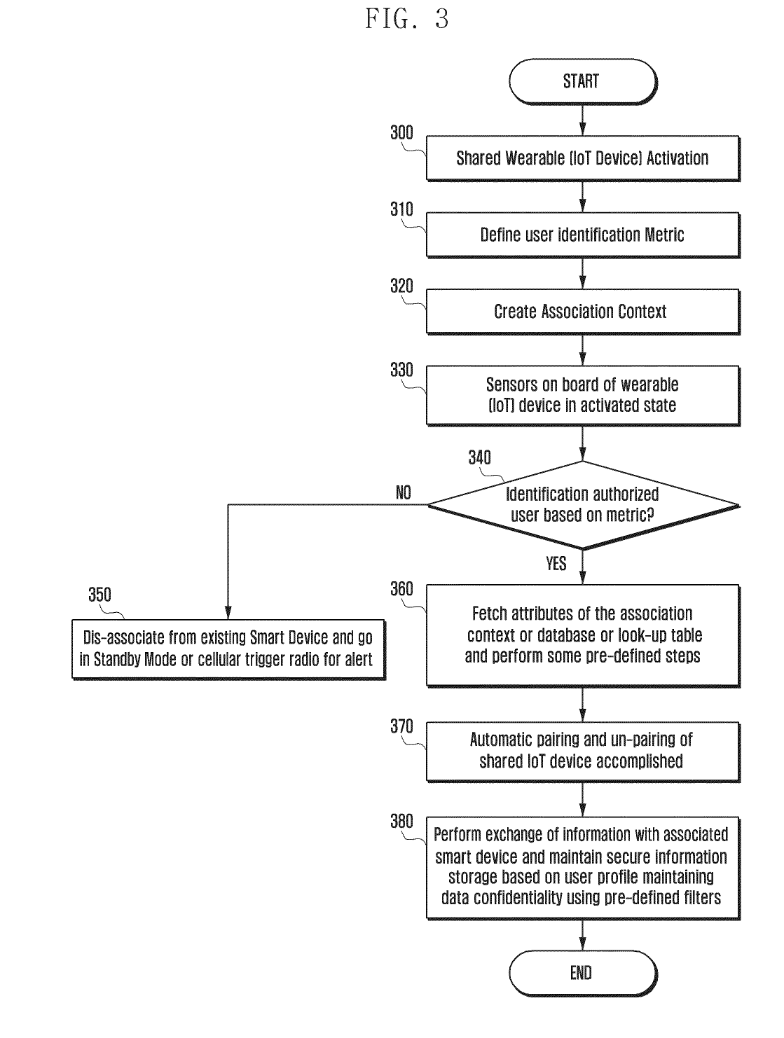

FIG. 3 illustrates a procedure for automatic association (pairing) according to an embodiment of the present disclosure.

Referring to FIG. 3, a flowchart is illustrated, such that an appropriate sensor on a wearable (e.g., an IoT device) is activated to capture a user identity metric of the user at operation 300.

By invoking an appropriate application program running on the wearable (e.g., the IoT device) the appropriate on board sensor captures the unique user identity metric for the creation of association context in the wearable (e.g., the IoT device) at operation 310.

Several attributes could be added to the unique user identity metric for the creation of association context associated with that user at operation 320. This operation is called pre-configuration where association context (list of user identity metric) for one or more authorized users of the shared wearable (e.g., the IoT device) is created in the wearable (e.g., the IoT device). At operation 310, all the authorized users and corresponding user identification metric are inputted. The respective user identification metric is tagged with list of smart devices as attributes belonging to those authorized users to create the association context at operation 320

Depending on the on board sensor the captured unique user identity metric at operation 310 is at least one of a finger print of the authorized user or image of the face of the authorized user, eye iris/retina of the authorized user, any biological parameter such as heart rate/blood flow rate/blood pressure/weight of the authorized user, and the length of the strap of the wearable based on thickness of the wrist of the authorized user. For example, the association context is created at operation 320 for user #1 220 (refer FIG. 2) based on his/her unique identity metric and tagged with the attribute of smart device #1 230 belonging to user #1 220. Similarly, association context is created at operation 320 for user #2 221 (refer FIG. 2) based on his/her unique identity metric and tagged with the attribute of smart device #2 231 belonging to user #2 221 so on and so forth. The wearable (e.g., the IoT device) is pre-configured at operation 320 by enriching the respective association context with several attributes such as smart device name belonging to that user or list of social networking applications associated with that user or other attributes mentioned for the smart car scenario.

In case the IoT device is a car console or a car dashboard the sensors, such as the finger print detection sensor and/or the weight measurement sensor, or the camera may be placed at multiple places like the steering wheel of the car (especially the finger print sensor) or the seat of the car may be equipped with weight measurement sensor or the backrest of the driver seat and navigation seat is equipped with camera. Since we are discussing the association procedure for pairing the IoT device with a smart device, the attribute tagged to the unique identity metric is the identity or name of the smart device. The smart device identity (e.g., smartphone) may be something like Bluetooth name which is normally set to the manufacturer and model of the smartphone. However, user friendly smart device identity can also be created by identifying the smart device by authorized user's name something like ‘John smartphone’ or ‘Bill laptop’ etc. However, it should be ensured that the same smart device name used in the association context attribute is also configured within the smart device, for example changing the default Bluetooth name set by the manufacturer and model of the phone to ‘John smartphone’ if ‘John smartphone’ is the attribute tagged to the user identity metric of John (i.e., user #1 220) in the association context created at operation 320. Alternatively, it may possible to use Bluetooth media access control (MAC) identifier (ID) of a smart device which will be unique as an attribute. The user does not need to input the Bluetooth MAC ID, but the wearable will fetch it from the smart phone when paired for the first time and store it into the association context as an attribute.

Assuming it is the first time that user #1 220 (refer FIG. 2) puts on the IoT device 200 (refer FIG. 2), the activated sensor at operation 330 captures the user identity for determining whether user #1 220 is an authorized user based on the identification metric at operation 340. To determine at operation 340 that user #1 220 is an authorized user, the IoT device performs a check with the association context for user identification.

If the user #1 220 is identified as an authorized user (i.e., user #1 220 according to FIG. 2) at operation 340, then some pre-defined operations as mentioned below are executed:

First, the attributes are fetched from the association context of the user including a list of smart devices (i.e., smart device #1 230 associated with user #1 220) in operation 360.

Second, the existing wearable pairing status is checked. If the wearable is already paired with some smart device, then the paired smart device is matched with the smart device #1 230 of user #1 220 based on the fetched attributes. If the smart device #1 230 name matches an already paired smart device name then nothing is done. If there is no matching then the existing device is automatically un-paired and then the wearable is paired with the smart device #1 230 belonging to user #1 220 based on the attribute tagged with user identity metric of user #1 220 in the association context in operation 370.

Third, if the wearable is not paired with any smart device, then a proximity communication interface like Bluetooth is enabled and the wearable is automatically paired with the smart device #1 230 belonging to user #1 220 if detected in operation 370.

Accordingly, a successful user identification at operation 340 would trigger the Bluetooth protocol pairing functionality and the shared wearable gets paired with the smart device #1 230 of the user #1 220 (assume John as user #1 referring to FIG. 2) at operation 370. After operation 370, an exchange of information is performed between the wearable and smart device #1 230 at operation 380.

If at operation 340 it is determined user #1 220 is not an authorized user, then the wearable dissociates from the existing smart device and goes into a standby mode or a cellular trigger radio for alert at operation 350. The operations mentioned in the automatic pairing/un-pairing procedure are merely listed in logical sequence to explain the working principle of the procedure. It should not be considered very restrictive to realize the automatic pairing/un-pairing procedure because the logical sequence may be slightly changed or some operations can be combined without deviating from the working principle of the procedure.

If user #1 220 removes the shared IoT device and user #2 221 (assume Bill as user #2 referring to FIG. 2) is now using the shared IoT device, the IoT device is still paired with user #1 220 smart device (i.e., John smartphone #1 230). Upon successful identification of user #2 221 at operation 340 by capturing the user identity metric at operation 330 and checking the association context the IoT device is able to detect/check change in user. Based on this operation at 340 some pre-defined operations are invoked as mentioned above where shared IoT device (200 referring to FIG. 2) shall disassociate itself from ‘John smartphone’ 230 and associate with ‘Bill laptop’ 231. Depending on how the association context is structured and enriched the data exchange performed by the respective user of the shared IoT device (wearable) is protected from privacy encroachment.

According to an embodiment of the present disclosure, upon successful detection of authorized user, IoT device performs at least one of: triggering the proximity connectivity protocol to perform connection release with currently associated smart device of previous user and connection setup with another smart device of another authorized user using the smart device attribute tagged to the user identity metric based on the association context querying.

According to an embodiment of the present disclosure, upon successful detection of authorized user and after establishing connection (association) with smart device, IoT device performs at least one of: exchange of information with associated smart device and secure information storage maintaining confidentiality of stored data based on pre-defined filters.

It is to be noted the proposed association procedure is explained using the Bluetooth protocol functionality for pairing. However, this is not the limiting case and it may be based on discovery functionality of any proximity connectivity interface like Wi-Fi, Zigbee etc.

In case of smart car it is not necessary that the car console or car dashboard (IoT) device always pairs with the smart device of the person sitting in the driver seat. This may be left to configuration of attributes of the association context. In some cases just the car ambience settings are tuned according to the person sitting is driver seat (private attributes activated) when he or she is the sole passenger in the car while when there are multiple passengers inside the car then the car ambience settings are tuned according to the family attribute (shared or public or open attribute) of the association context.

According to an embodiment of the present disclosure, upon successful detection of authorized user or users IoT device (car console or dash board) performs at least one of the actions: setting the audio/video directory, air freshener or car perfume settings, inside car lighting settings or driver seat adjustment settings based on pre-defined filters (i.e., either activating a private attribute associated with the user sitting in the driver seat if he or she is alone or activating shared or public attribute associated with the user sitting in the driver seat if accompanied by a fellow passenger, such as family.

### Unauthorized Usage Detection

Referring again to FIG. 2, if user #1 220 removes the wearable 200 and user #N (assume unauthorized user whose association context is not available in the wearable 200) is now using the wearable 200, the wearable 200 is still paired with the smart device #1 230 (i.e., John smartphone 230) of user #1 220. Upon capturing the user identity metric of user #N and checking the association context the wearable 200 is able to detect that user #N user identity metric does not match with any user identity metric stored in the available association context. Now referring back to operation 340 as shown in FIG. 3 when the user identification fails then the IoT 200 may perform at least one the following operations depending on the usage scenario.

The wearable 200 may merely disassociate itself from existing smart device ‘John smartphone’ 230 (if still paired) to protect the privacy of user #1 220. Before disassociating (un-pairing) the wearable 200 may send an alert to user #1 220 (i.e., John smartphone 230) to notify unauthorized usage of the wearable 200.

The wearable 200 may completely disable the automatic association procedure so that unauthorized user cannot pair the wearable 200 with any of his/her device even manually.

In some scenarios if the wearable 200 is not initially paired with authorized user device and it has cellular radio capability (e.g., global system for mobile communications (GSM) connectivity, universal mobile telecommunications system (UMTS) connectivity, long term evolution (LTE) connectivity, or code division multiple access (CDMA) connectivity, etc.), then upon detection of unauthorized usage it may trigger the cellular radio ON if OFF and it may trigger mobile originated call. The mobile originated call may also be triggered if cellular radio inside the wearable 200 is in sleep state to active state according to mode of the cellular radio (e.g., GSM, UMTS, LTE, or CDMA radio, etc.).

On triggering the cellular radio the wearable 200 may send a notification with captured snapshot data like location information and user identity metric of unauthorized user etc. via cellular link to the user #1 220 who is authorized user (primary user or master user) of the wearable 200. Alternatively, wearable may send notification/alert to one or more authorized users configured in the association context.

In case of a smart car, if the IoT device (car console or car dash board) was not initially paired with authorized user smart device (i.e., smartphone of the owner of car) and the car console or car dash board has cellular radio capability (e.g., GSM, UMTS, LTE, or CDMA, etc.), then upon detection of unauthorized usage (assuming intruder is expert in disabling the in-built alarm functionality of car and manages to slip inside the car) it may trigger the cellular radio ON if OFF and it may trigger mobile originated call. The mobile originated call may also be triggered if cellular radio equipped in the IoT device is in sleep state to active state according to mode of the cellular radio so that notification is sent to the authorized user smart device (e.g., smartphone) indicating his/her car is getting stolen.

According to an embodiment of the present disclosure, upon detection of unauthorized usage of IoT device at least one of: disabling the automatic association functionality and sending an alert to primary user and/or one or more authorized user either through proximity connectivity or cellular connectivity.

According to an embodiment of the present disclosure, upon detection of unauthorized usage of IoT device if alert notification is sent to primary user and/or one or more authorized user then it includes at least one of: user identity metric of unauthorized user and location information if available.

Shared Device Scenario

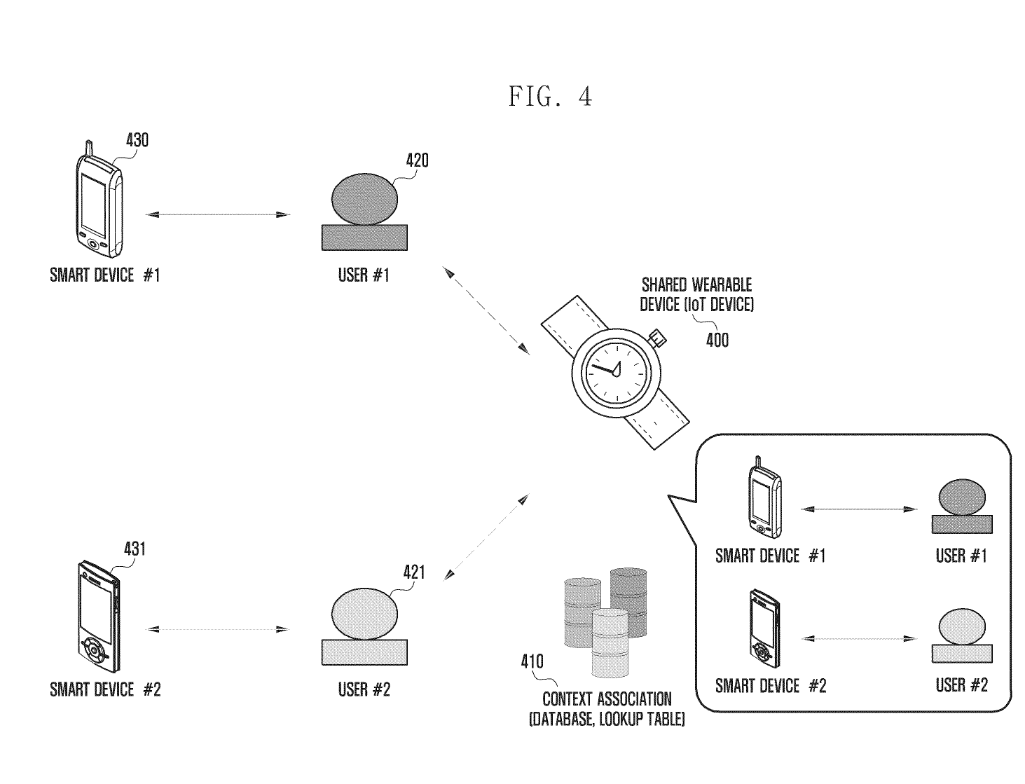

FIG. 4 illustrates a shared device scenario between authorized users according to an embodiment of the present disclosure.

Referring to FIG. 4, a wearable device 400 (e.g., an IoT device) that is shared with user #1 420 and user #2 421 is illustrated, such that all details of the authorized users among whom the wearable device 400 is shared, are pre-configured into the wearable device 400 residing in an association context 410 (e.g., a context association stored in a database or a look-up table) along with smart device names of user #1 420 (i.e., smart device #1 430) and user #2 421 (i.e., smart device #2 431) tagged to the user identity metric of user #1 420 and user #2 421 respectively.

Since a smart car having a car console/dashboard equipped with an IoT device is shared with user #1 420 or user #2 421 or an entire family, all the details of the authorized users among whom the car is shared, are pre-configured into the car console/dashboard residing in the association context along with smart device names of user #1, user #2 and other members of family tagged to the user identity metric of user #1 and user #2 and also the car ambience settings as attributes.

In another scenario, the car ambience settings like the audio/video file directory, the air freshener or car perfume setting, the seat adjustment settings etc. is according to user #1 420 who is currently occupying the driver seat (assuming private attribute is activated for user #1 420). After driving the car for some distance user #1 420 picks up a friend who is neither part of the family nor is an authorized user. However, since the car ambience setting is a private setting to user #1 420, when his/her friend accompanies in the car, the association context residing in the car console/dashboard detects another co-passenger in the car and identifies he/she is neither member of the family nor an authorized user, then it may de-activate the private setting of user #1 420 so that his privacy is not compromised and activates a shared setting using the shared association context (shared attribute or public attribute is activated while private attribute is de-activated).

In another scenario, the car console/dashboard equipped with the IoT device is paired with smart device #1 430 of user #1 420 who is currently occupying the driver seat and also paired with smart device #2 431 of user #2 421, if user #2 421 is co-passenger in the car and user #2 421 is a family member. Since user #1 420 is driving the car the only useful interaction he/she can have with the car console/dashboard is for notification from his/her smart device #1 430 to display on the car console or for navigation commands on the display of the car dashboard. However, user #2 421 who is co-passenger either in navigator seat or passenger seat can have more active interaction with the console/dashboard in terms of using the display for playing games or watching video provided it does not distract user #1 420 who is occupying the driver seat.

Such interactive use of the console is possible if the display on the backrest of the driver seat or navigator seat is activated when user #2 421 is sitting in the passenger seat. If user #2 421 is sitting in navigator seat then it seems reasonable to deactivate entertainment video on the display of the car console/dashboard since it will distract user #1 420 who is driving the car such that safe driving is given the most importance. In this scenario even though the console is paired with multiple smart devices (i.e., the smart devices #1 430 and #2 431 of user #1 420 and user #2 421) the control is with user #2 421 to enjoy the smart car environment. However, when there is call on the smart device #1 430 of user #1 420 or some important message has arrived for him/her then an interrupt signal is sent to the console which would result in getting the control to user #1 420 and freezing the activity of user #2 421. Once the interaction of smart device #1 430 of user #1 420 and the car console/dashboard equipped with the IoT device is over then the control is reverted back to user #2 421 from the point where the activity was frozen.

In another scenario like smart home or smart small office or smart school where the IoT device is shared with multiple users to share the resources in the smart environment. For example, user #1 420 main device (i.e., smart phone #1 430) is connected to smart speaker or smart TV or smart display or tablet etc. either as single connection or as simultaneous connections with above shared devices connected through a shared IoT device. So, user #1 420 is enjoying either the smart home or smart office or smart environment according to his/her private settings for the interaction with various devices (here private setting would mean since user #1 420 is alone in the smart environment so he/she is enjoying the video on smart TV or smart display, listening to loud and high quality music from smart speaker etc.). When the IoT device detects that another user #2 421 is coming in proximity of user #1 420, then in order not to encroach his privacy the IoT device deactivates the private settings of user #1 420 by disconnecting the speaker if music from the smart device #1 430 of user #1 420 is played on the speaker, or disconnects the smart TV or smart display if something from user #1 420 smart device is displayed on the big display of TV while activating the public setting.

After activating the public setting user #1 420 continues enjoying music through his headphone instead of speaker and continues enjoying video on his smart phone (e.g., smart device #2 430) instead of TV (here public setting means when authorized users of the shared environment are detected then individual usage of shared resources is restricted so that other authorized users are not disturbed). Therefore the privacy issues of user #1 420 are not compromised in shared environment scenario when shared IoT device detects another user #2 421. Further, if the shared environment is used for group activity among the authorized users like watching a football match or movie on the smart TV then the group setting is activated where the audio is played on the smart speakers. The shared resources of the shared smart environment may be connected through the IoT device.

In another scenario like a smart hotel, where the guest rooms of the hotel will be shared among many guests staying/visiting the hotel on a time basis (i.e., hotel room is shared when one guest check-out and another guest check-in). In this scenario the smart hotel room with all the resources of the room like TV, Refrigerator, washing machine, lighting, heating, ventilating, and air conditioning (HVAC), door lock etc. will be the shared entity among multiple users on a time basis. Frequent visiting guest's association context can be stored on the hotel servers or room gateway or guest's smart phone with unique identification metric like mobile phone number, his/her passport or social security number, his/her smart phone's wireless MAC identifier (e.g., Bluetooth or NFC MAC ID) or membership number of loyalty program for frequent guests etc. Hotel server will also have room booking or reservation details and corresponding guest details with identification metric. One way of authentication of the guest can be performed by the devices like smart door lock which can recognize the unique pin or mobile number, or guest smart phone's hardware details etc., or by device like camera at the door which can authenticate guest by the techniques like by face detection, iris detection etc. After authentication is successful based on user identification, the association context of the corresponding guest will be fetched from any possible sources like guest's mobile phone/wearable, or any device in the room like gateway, or hotel server etc. to activate the attributes (i.e., settings of the guest room) tagged to the user identity metric in the association context. When the attributes are activated all the devices/resources inside the guest room allocated to the guest will be configured as per the guest's preferences when he/she check-in. Guest might set preferences like preferred room temperature level, preferred humidity level, favorite TV channels, room lighting, housekeeping preferences, additional services (e.g., food, gym, transport, swimming pool etc.) subscriptions etc.

According to an embodiment of the present disclosure, if private settings were activated for a particular user, upon detection of another shared user by IoT device in the vicinity, the private setting is de-activated and the public settings are activated without interruption in user activity and protecting the user privacy. The user identity metric for uniquely identify the user can be anything with which the user can be identified.

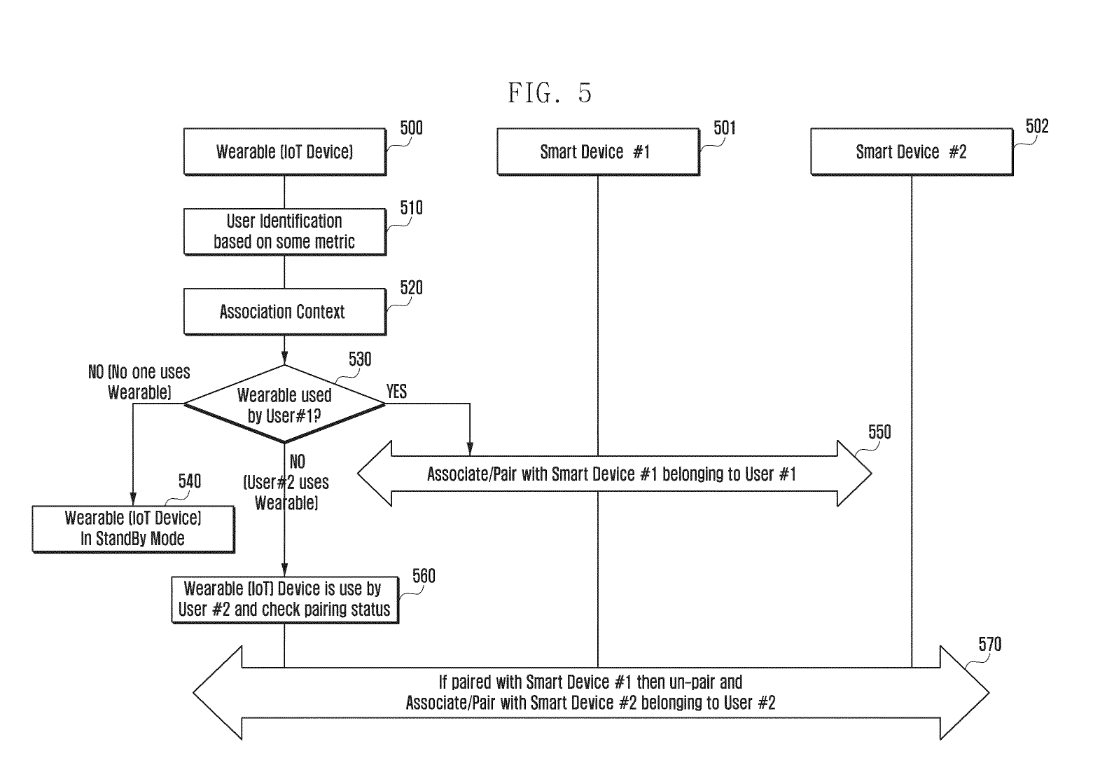

FIG. 5 illustrates an automatic association procedure for a shared device scenario according to an embodiment of the present disclosure. It is assumed that with sensors on a wearable, that the wearable detects when a user wears or removes the wearable and upon identification of change in user the association/pairing procedure is triggered. The detailed association/pairing procedure is described in FIG. 3.

Referring to FIG. 5, a procedure is illustrated, such that it is assumed a wearable 500 (e.g., an IoT device) (400 referring to FIG. 4) is currently used by user #1 420 and therefore is associated with smart device #1 501 (430 referring to FIG. 4) which belongs to user #1 420 (i.e., current activated association context refers to user #1 420).

In operation 510 the pre-defined user identity metric of the user is captured by the activated onboard sensor on the wearable 500. At operation 520 the association context residing in the wearable 500 is invoked for user identification to authenticate the user identity metric captured in operation 510.

After invoking the association context at operation 520, the wearable 500 is able to detect if user #2 421 (of FIG. 4) of the wearable 500 is an authorized user by ascertaining the user identity metric captured in operation 510 with the stored user identity metric in the invoked association context. After user identification the wearable 500 compares the invoked association context with the current activated association context for checking if there is change in user at operation 530.

If the user identity data of user #2 421 captured by the onboard sensor at operation 510 of the wearable 500 matches with the user identity metric retrieved from the invoked association context at operation 520, then user #2 421 will be identified as the authorized user and the wearable 500 performs one or more predefined operations mentioned below.

Check if there is change in user at operation 530 as explained above. If there is no change in user the wearable 500 keeps the association context activated for user #1 420. Since wearable 500 is already paired with a smart device #1 501 (i.e., smart device #1 430 belonging to user #1 by referring to FIG. 4), then verify if the paired smart device #1 501 belongs to the user #1 420. If smart device #1 501 belongs to the user #1 420, then nothing to be done, pairing status will be maintained as it is as shown in operation 550 (in this case activated association context refers to smart device #1 501).

If there is change in user, set the current activated association context to that of user #2 421 and get the smart device details of the corresponding user (i.e., user #2 421). Check the pairing status of the wearable 500 at operation 560. If the wearable 500 is already paired with a smart device #1 501 (430 referring to FIG. 4), then verify if the paired smart device #1 501 belongs to the user #2 421. Since smart device #1 501 belongs to the user #1 420, and there is change in activated association context, then at operation 570 wearable 500 disassociate (un-pairs) with the smart device #1 501, and associates (pairs) with smart device #2 502 (431 referring to FIG. 4) based on the activated association context it will discover smart device #2 502 (431 referring to FIG. 4) is belonging to user #2 421 (in this case activated association context refers to smart device #2 502).

If wearable 500 is not paired with any smart device (i.e., it is in standby mode), then upon user identification (in this case user #2 421 is authorized) the wearable device 500 activates the association context for user #2 421 and auto pairs with the user's smart device pre-configured in the activated association context (in this case at operation 560 the activated association context refers to smart device #2 502).

If the user identity data of a user who is currently wearing the wearable 500 captured by the onboard sensor at operation 510 does not match with the user identity metric retrieved from the association context at operation 520, then the user will be treated as unauthorized user at operation 530 and wearable 500 automatically performs at least one of the following pre-defined tasks. These predefined tasks can be turning on the cellular radio capability of the wearable 500 (if equipped with 2G/3G/4G) and send notification to the primary user of the device; automatically un-pair the wearable 500 if already paired with some smart device and disable the automatic association (pairing) feature of the wearable 500 etc.

Upon removing the wearable 500, the wearable 500 auto detects and un-pairs with the smart device and enters a standby mode at operation 540.

### Connecting to Nearest Smart Device:

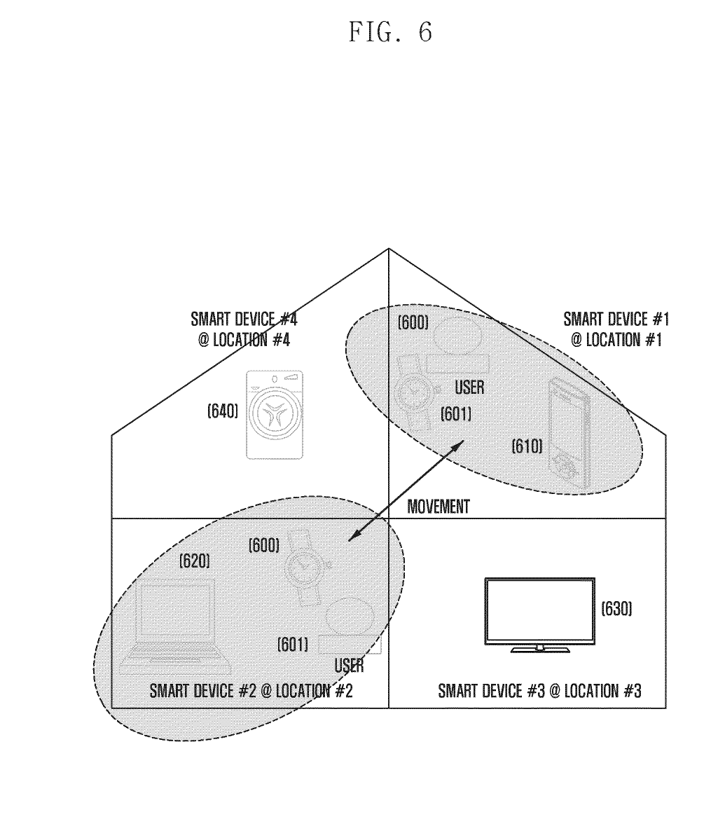

FIG. 6 illustrates smart pairing to multiple devices in a smart home environment according to an embodiment of the present disclosure. Smart pairing to multiple devices means switching pairing among multiple devices of a user, such that an IoT device is paired to any one smart device at a given time from a plurality of smart devices.

Referring to FIG. 6, a smart home environment is illustrated, such that in the smart home environment a wearable 600 (e.g., an IoT device) is required to pair to multiple devices in different locations in the home.

Depending on user 601 movement in the home it would be desirable that the wearable 600 associates with the nearest smart device. This is possible through the proposed automatic association procedure and enriched association context as described in FIG. 3. Multiple smart devices (e.g., smart device #1 610 at location #1, smart device #2 620 at location #2, smart device #3 630 at location #3, smart device #4 640 at location #4 etc.) of the authorized user 601 are located at different locations in the home and the multiple smart devices are tagged with user identity metric in the association context of user 601.

User 601 of the wearable 600 may have multiple smart devices at home in different rooms. When user is in a living room, then the wearable 600 shall automatically pair with the device present in the living room. If the user moves to a bedroom, then the wearable 600 automatically pairs with a device present in the bedroom. The wearable 600 always connects to the nearest smart device of the user 601 such that battery power of both the wearable 600 and the smart device are saved.

Accordingly, auto pairing with the nearest smart device would help not only in saving the battery power of the wearable 600 but also providing a seamless service in terms of user experience.

As shown in FIG. 6, the wearable 600 is paired with smart device #1 610 when the user 601 is in location #1 of his/her home. When the user 601 moves from location #1 to location #2 of his/her home along with the wearable 600 then the wearable 600 would pair with the nearest smart device #2 620 at location #2 and un-pair from the smart device #1 610 at location #1 because smart device #1 610 is far compared to smart device #2 620 with respect to the location of the wearable 600.

If the smart device is a mobile device like a smart phone, laptop or a tablet etc., then the battery level of the smart device also will be considered while auto-pairing the wearable 600. The wearable 600 may be periodically receiving updates of the battery level of the smart device to which it is connected. The connectivity protocols like Bluetooth provides a mechanism for exchanging the battery level information between the connected devices. If the wearable 600 detects that the battery level of the connected smart device reaches lower than the preconfigured level, then wearable automatically scans for any other smart devices in the vicinity with a better battery level than the current paired smart device. If there is/are other smart device/s with better battery level discovered by the wearable 600, then at least one of the following is performed. The proximity connectivity interface such as Bluetooth pairing functionality is triggered to check if there are other smart devices in vicinity based on the list in the association context. If other smart device from list is detected then the battery level of the smart devices with respect to all detected devices is estimated and compared. The wearable 600 disassociates with currently paired device and associates with the smart device having the highest battery level.

The wearable 600 may perform signal strength measurement with the paired smart device and also account for the battery power level of the smart device. Based on these two metrics (i.e., signal strength measurement and/or battery power level) the IoT device automatically pairs with the smart device such that battery power consumption of the both the IoT wearable and smart device will be minimized.

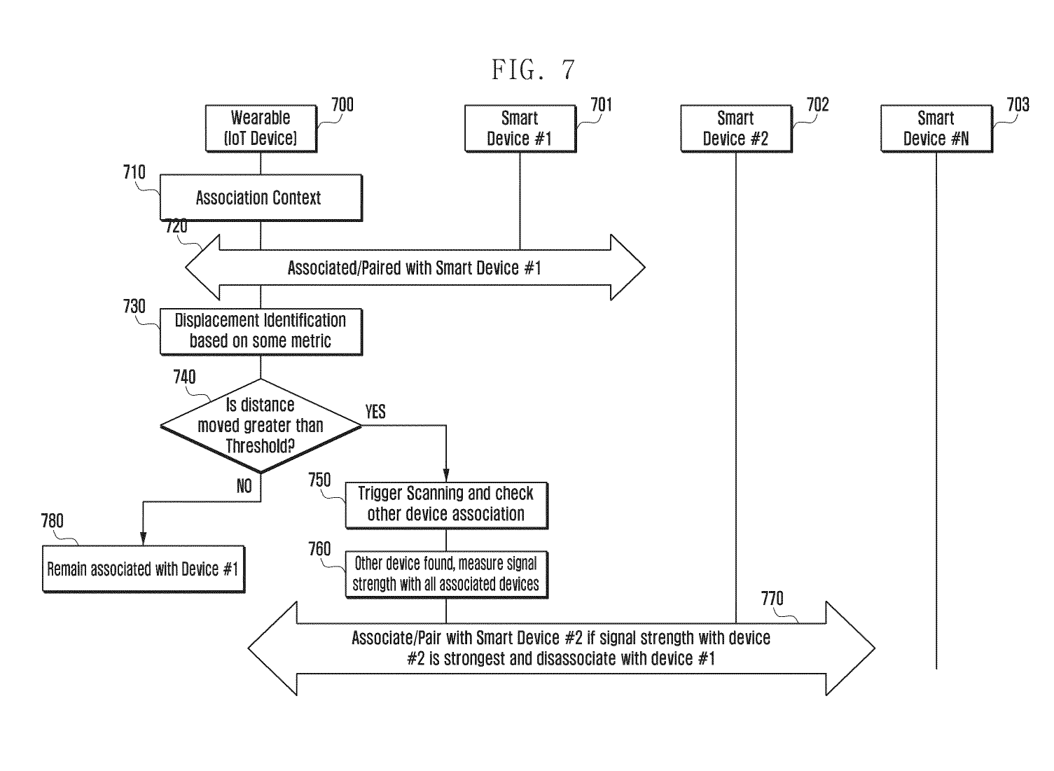

FIG. 7 illustrates a procedure to connect to a nearest smart device in a home environment according to an embodiment of the present disclosure.

Referring to FIG. 7, an IoT device 700, such as a wearable device, is illustrated, where the IoT device 700 is currently associated with smart device #1 701 using the proposed automatic association/pairing procedure such that smart device #1 701 placed at location #1 gets paired since a currently identified user is also located at location #1. FIG. 7 illustrates the process of the IoT device 700 connecting to one of smart device #1 701, smart device #2 702 and smart device #N 703.

Operations 710 and 720 are performed according to operations 300, 310, 320, 330, 340, 350, 360, 370 and 380, as illustrated in and as described with respect to FIG. 3.

It is assumed the IoT device 700 is equipped with a displacement sensor such as a pedometer. At operation 730 the IoT device 700 identifies displacement then it updates the distance covered by the movement of the user. The displacement sensor may also be optionally assisted with indoor positioning mechanisms if equipped in the IoT device 700 to more accurately estimate the distance based on location information.

The sensor (pedometer) detects the current user's movement and identifies the movement by accounting for number of steps taken by the user compared to first step update when movement was detected to estimate if the distance is above a pre-defined threshold at operation 740. If the distance moved by the IoT device 700 is above a pre-defined threshold then some pre-defined actions are invoked. During an observation window the displacement sensor (pedometer) estimates the number of steps (current location if equipped with indoor positioning mechanism) and stores it for future comparison when the observation window is invoked next time. Comparing the displacement (optionally location) samples from the two observation windows the distance moved is estimated and compared with a threshold value. The displacement metric may be combined with the battery level metric of the currently paired smart device and compared with threshold value.

If the estimated distance or displacement and/or battery level is greater (and/or lower) than a threshold then at least one of the following is performed. The proximity connectivity interface such as Bluetooth pairing functionality is triggered to check if there are other smart devices in vicinity based on the list in the association context at operation 750.

Assuming the user has moved to location #2 in the home environment (refer to FIG. 6) and the distance estimated by the displacement sensor is greater than the pre-configured threshold (and/or battery level is lower than the pre-configured value), the IoT device 700 detects smart device #2 702 (620 with reference to FIG. 6). If another smart device from the list is detected then the signal strength (either as power measurement in decibel-milliwatts (dBm) or signal to noise ratio measurement in decibels (dB) and/or battery level) with respect to all detected devices is estimated and compared at operation 760.

The IoT device 700 compares the signal strength measurement between itself and smart device #1 701 (currently paired device and battery level of smart device #1 701) and the signal strength measurement between itself and smart device #2 702 (device detected at location #2 and belonging to device list in the association context and battery level of smart device #2 702). IoT device 700 associates with the smart device having the strongest signal strength (and/or highest battery level) and disassociates from the currently paired device at operation 770. Based on the signal strength and/or battery level comparison if the signal strength and/or battery level with respect to smart device #2 is highest then IoT device 700 un-pairs from smart device #1 701 at location #1 and pairs with smart device #2 702 at location #2.

If, at operation 740, the estimated distance or displacement is smaller than a threshold and/or the battery level is above a threshold then the pairing between wearable 700 and a smart device #1 701 remains at operation 780.

According to an embodiment of the present disclosure, upon detection of displacement above a threshold value, the IoT device 700 performs at least one of: triggering the proximity connectivity protocol to perform connection release with currently associated smart device; and connection setup with another smart device based on the comparative signal strength and/or battery level and using the smart device attribute tagged to the user identity metric based on the association context querying.

According to an embodiment of the present disclosure, upon detection of battery level below a threshold value of currently associated smart device, IoT device 700 performs at least one of: triggering the proximity connectivity protocol to perform connection release with currently associated smart device; and connection setup with another smart device based on the comparative signal strength and/or battery level and using the smart device attribute tagged to the user identity metric based on the association context querying.

### Auto Triggering Cellular Radio Capable IoT Device

Recently wearables are launched in the market with 3G/4G radio capability. In future with the standardisation of Category 0 user equipment (UE) category in 3^{rd} generation partnership project (3GPP) standardization (Rel-12) many more such devices having LTE low cost MTC capability will be available embedded in wearable (IoT devices).

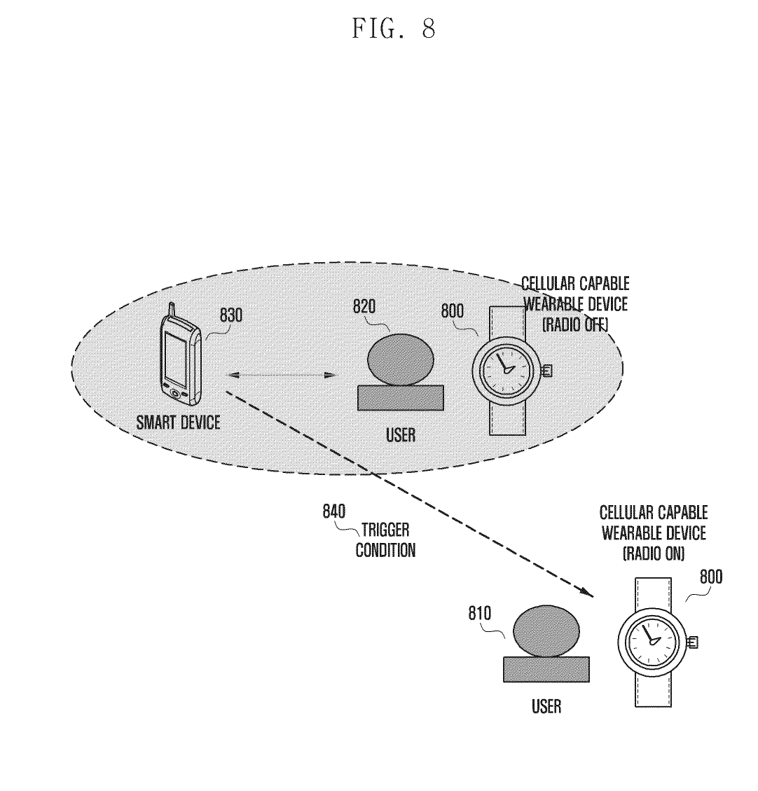

FIG. 8 illustrates automatic triggering of a cellular radio communication capability of an IoT device according to an embodiment of the present disclosure

Referring to FIG. 8, a wearable 800 paired with a smart device 830 is illustrated, where it is assumed that when the wearable 800 is paired with the smart device 830 of a user 820, the cellular capability of the wearable 800 (e.g., an IoT device) is OFF.

It may be also assumed that such paired wearable 800 may have its own subscription identity (subscriber identity module (SIM)/universal integrated circuit card (UICC)) or may share the subscription identity (SIM/UICC) of the authorized paired smart device using the SIM access profile (SAP) defined in Bluetooth specification. Further, it can also be assumed such cellular capable wearable 800 may have very long sleep cycles configured (on order few seconds/minutes) in order to save battery. Wearable technology will be adopted for many use cases like physical fitness, kid-care, childcare and eldercare, etc. in future. Conserving battery power will be most important requirement for such cellular capable wearable 800.

Also, depending on the use case, there will be requirement for some trigger condition 840 to either turn ON the cellular radio if OFF; or wake-up the cellular radio from sleep cycle to trigger mobile initiated call for sending notification in emergency situations which may prove fatal to the user. For such functionality it is assumed the wearable 800 has on board sensors (e.g., camera, fingerprint scanner, accelerometer, gyroscope, etc.) that are activated. The following use cases are expected to gain market penetration requiring the above mentioned functionality. Health care or physical fitness related wearables having cellular capability (3G/4G) would need the triggering of the cellular radio when the user 810 leaves home environment to do sports activity involving running, jogging, cycling, etc. in which case the wearable 800 is no more paired with the smart device 830 and the user does not carry the smart device 830 (smartphone) while doing physical activity.

In such a scenario the wearable 800 needs to detect trigger condition 840 which would turn ON the cellular radio automatically when the user takes outdoors for physical activity. Wearables having cellular capability (3G/4G) are expected to be widely used for childcare/kid-care/eldercare scenarios where the cellular capable wearable (IoT device) is in standby mode (means not paired with associated smart device 830) and there is a need (e.g., a trigger condition 840) to either turn ON the cellular radio automatically or wake-up the cellular radio from sleep cycle to trigger mobile initiated call to send notification to smart device (smartphone) 830 through cellular link to notify either parents of a kid or a caretaker of elderly people in case of unwanted incident which may prove fatal.

In case of childcare/kid-care the kid may be dropped at day-care facility by working parents or children may be at school or playground and if any unwanted incident happens which is harmful/fatal to the kid/child 810 then there is a need (trigger condition 840) the wearable 800 shall be able to send alert notification to parents 820 on the smart phone 830. In case of eldercare the elderly person 810 while performing regularly activity like walking in garden, sleeping in bed, climbing up stairs (or walking down stairs) experience an accident (such as falling down due to losing control) then the wearable 800 shall be able to detect trigger condition 840 to send alert notification to caretaker 820 on the smart phone 830.

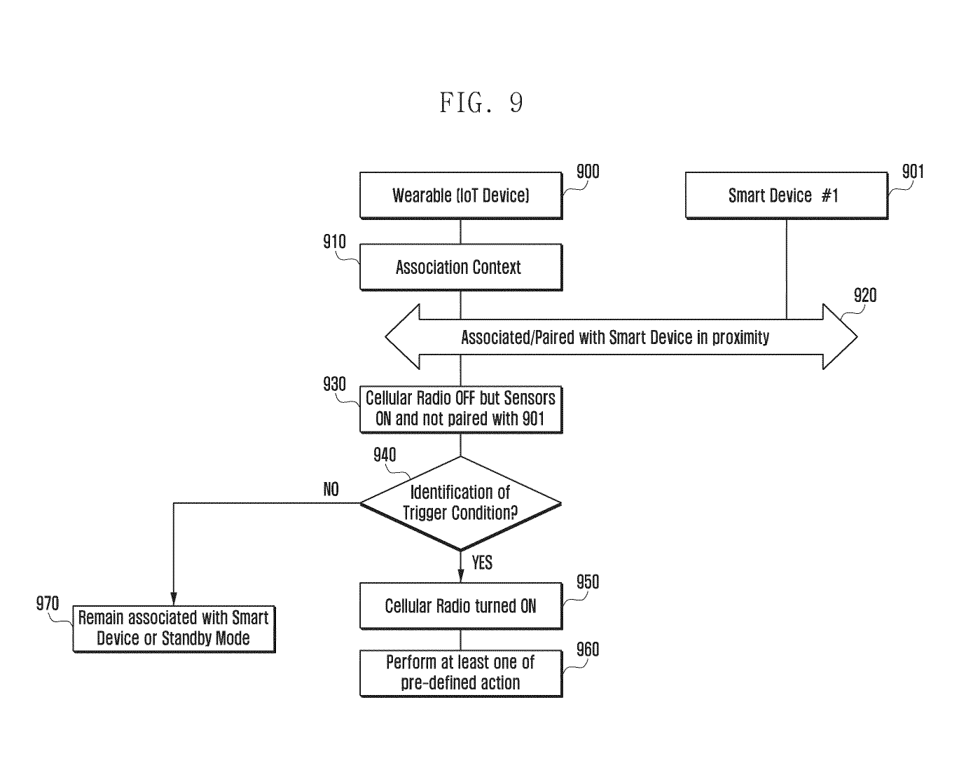

FIG. 9 illustrates a general procedure for sending an alert notification to an authorized user according to an embodiment of the present disclosure.

Referring to FIG. 9, a wearable 900 (e.g., an IoT device) and a smart device #1 901 are illustrated, where the wearable 900 has cellular radio capability and is normally associated with the smart device #1 901 when it is close proximity.

This pairing at operations 910 and 920 may be based on the proposed automatic association/pairing operations 300, 310, 320, 330, 340, 350, 360, 370 and 380, as illustrated in and as described with respect to FIG. 3.

When the wearable 900 is already paired with the smart device 901, the radio capability is turned OFF. In another scenario the wearable 900 may be in standby mode (i.e., not paired with a smart device) when it is not in proximity of the smart device 901 and may either have cellular radio capability turned OFF or if ON then it may be in long sleep cycle at operation 930. So, for the different use cases mentioned above there is need to identify a trigger condition (operation 840 referring to FIG. 8) to either turn ON the cellular radio capability if OFF or wake-up the cellular radio from long sleep cycle to trigger mobile initiated call if the trigger condition is met.

At operation 940 if the pre-defined trigger condition is met then at least one of the following actions performed. At operation 950 a cellular radio capability of the wearable 900 is turned ON and the wearable 900 is used to send/receive messages, make calls, or send notifications if not in proximity of smart device 901. At operation 950 the cellular radio capability of the wearable is turned ON or the cellular radio is woke up from a long sleep cycle and a connection establishment procedure is started with a cellular network.

At operation 960, after connection establishment, an alert notification is sent to the receiver (parents/caretaker) including a snapshot of the incident (unwanted incident to child/kid or accident of elderly person) in the form picture, audio or video clip and/or live streaming of incident etc.

The trigger condition 840 (refer to FIG. 8) for such alerting could be pre-defined and tagged as an attribute to the user identity metric in the association context described above. The association context can be enriched by tagging the user identity metric with the trigger condition.

As shown in FIG. 8, the trigger condition could be based on at least one or a combination of more than one attribute as follows: a biological parameter like heart rate, blood pressure (the user identity metric itself); or emotional gesture attribute like crying, shouting, yelling (for kid-care at day care); or speech attribute like use of abusive words, help-help call (childcare at school or playground); or gravitational fall threshold (eldercare) or smoke detection attribute (childcare).

If, in operation 940 the trigger condition is not identified, then operation 970 is performed to keep the wearable 900 associated with the smart device #1 901 or to place the wearable 900 in a standby mode.

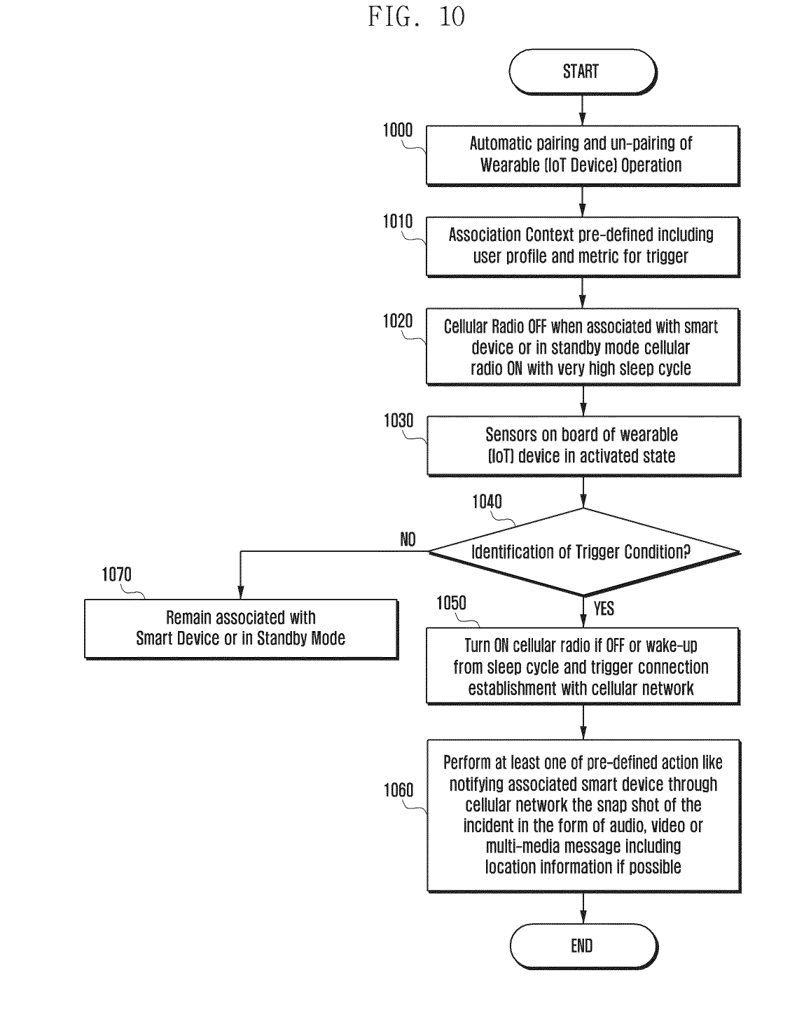

FIG. 10 illustrates a specific procedure for sending an alert notification to an authorized user according to an embodiment of the present disclosure.

Referring to FIG. 10, a procedure is illustrated, such that if a trigger condition is not detected then a wearable (IoT) remains either associated with a smart device or remains in a standby mode. The automatic triggering of the cellular capability of the wearable device for a specific case of elderly care is described here. The wearable (IoT) device (900 referring to FIG. 9) having a cellular radio capability is normally associated with a smart device (901 referring to FIG. 9) when it is in close proximity. But when the elderly person wearing the wearable device goes out of the proximity range from the smart device, then the wearable device cannot be paired with the smart device based on proximity connectivity such as Bluetooth.

When the elderly person wears the wearable device, then the identification of the person based on user authentication metric may be based on the proposed automatic association/pairing procedure described in FIG. 3. When wearable detects that the device is worn by a person, then sensors on board of the wearable device will be activated for user identification and authentication at operation 1000.

The user identification details collected from sensors on board of the wearable device are used to create the association context through an application program and stored in the wearable device at operation 1010. The association context with respect to an elderly care scenario can contain one or more user identity metric for at least one of any biological parameters of the user like heart rate, blood pressure rate etc. and trigger condition such as displacement threshold (such as gravitational fall threshold) to detect the fall of the elderly person.

Considering that the elderly person is not within the proximity of his/her smart device, the cellular capable wearable device radio will either be turned OFF or wearable device enters the standby mode such that the cellular radio is in a deep sleep cycle at operation 1020.

The wearable sensors only which are required as per the user identity metric or trigger condition defined in operation 1010 to form the association context are enabled on the wearable device at operation 1030. The sensors on board of the wearable device are activated when the user is wearing the wearable device to capture the user identity metric and/or trigger condition to match with the association context details after fetching from the association context to check if he/she is an authorized user.

At operation 1040, after authenticating the elderly person as the authorized user, the wearable will gather data from all the required onboard sensors of the wearable device to detect the trigger condition to turn ON the cellular radio or wake-up the cellular radio from sleep cycle. For example, if the elderly person was sleeping in bed or taking the stair-case for climbing up or coming down and if he/she falls due to losing control then the onboard sensor would detect the gravitational fall through the onboard sensor such as accelerometer or gyroscope or any other appropriate sensor and match for data captured through the sensor with the trigger condition configured in the association context for identification of the trigger condition.

If the cellular capable wearable detects that the trigger condition is met based on the captured data received from the onboard sensor of the wearable, the wearable soon turns ON the cellular radio of the device if OFF or wakes-up from the sleep cycle and triggers connection establishment with the cellular network at operation 1050.

After the wearable establishes the cellular connection with the network, it performs at least one of the pre-defined actions like notifying smart device of care taker associated with elderly person configured in the association context or any authorized users configured smart device through cellular network with the snap shot of the incident at operation 1060. The snap shot of the incident can contain any useful information about the incident like audio, video etc. of the elderly person who is wearing the wearable device, current location of the elderly person where incident happened, live audio/video streaming with the configured smart device, the speed of fall if wearable detected fall of the person etc.

If the wearable device detects at operation 1040 that the triggered condition is not met based on the captured data received from the onboard sensor, then it will be remain associated with the smart device of the elderly person if wearable is within the proximity of the smart device, else enters standby mode with the onboard sensors active for monitoring the trigger condition. As shown in FIG. 10 if the trigger condition is not detected then wearable (IoT device) remains either associated with smart device or remains in standby mode at operation 1070.

According to an embodiment of the present disclosure, the attribute to auto trigger IoT device having radio capability can be at least one of the following: a biological parameter like heart rate, blood pressure; emotional gesture attribute like crying, shouting, yelling; speech attribute like use of abusive words, help-help; gravitational fall threshold and smoke detection threshold.

For physical fitness use case, cellular radio capable wearable turned OFF in home environment. The cellular capable wearable can be turned ON/OFF automatically based on the biological metric like heart rate, blood flow rate etc. which would be above threshold when user doing physical activity.

For the day-care use case, case when baby is normal and happy in daycare so cellular radio capable wearable OFF. The cellular capable wearable can be turned ON automatically or wake-up the cellular radio from long sleep cycle if already ON based on emotional gesture recognition like crying when baby is left in day-care facility. Auto trigger notify parents for quick action and save battery of wearable. The cellular capable wearable can be turned ON automatically or wake-up the cellular radio from long sleep cycle if already ON if it is detached from the baby intentionally when left in day-care facility to notify parents

For childcare use case, children when normal at school i.e., playing and studying in school so cellular radio capability of wearable OFF. The cellular radio capability of wearable can be turned ON automatically or wake-up the cellular radio from long sleep cycle if already ON based on emotional gesture or speech recognition like yelling or use of abusive language etc. when child is at school or playground having quarrel. Auto trigger notify parents for quick action and save battery of wearable

For childcare use case the cellular radio capability of wearable can be turned ON automatically or wake-up the cellular radio from long sleep cycle if already ON based on speech recognition like ‘help-help call’ when child is getting kidnapped by anti-social elements. Auto trigger notify parents for quick action and save battery of wearable

For childcare use case, the cellular radio capability of wearable can be turned ON automatically or wake-up the cellular radio from long sleep cycle if already ON based on smoke detection when due to new change in life style child may be exposed bad company and starts smoking cigarettes. Auto trigger notify parents for quick action and save battery of wearable.

For childcare use case, the cellular radio capability of wearable can be turned ON automatically or wake-up the cellular radio from long sleep cycle if already ON based on location and time attribute when child goes out of the school campus during school working hours. Auto trigger notify parents for quick action and save battery of wearable.

The eldercare use case, the cellular capable wearable is OFF during normal activity of elderly person. The cellular capable wearable can be turned ON automatically or wake-up the cellular radio from long sleep cycle if already ON based on gravitational fall detected by accelerometer when elderly person falls. Auto trigger notify caretaker for quick action and save battery of wearable.

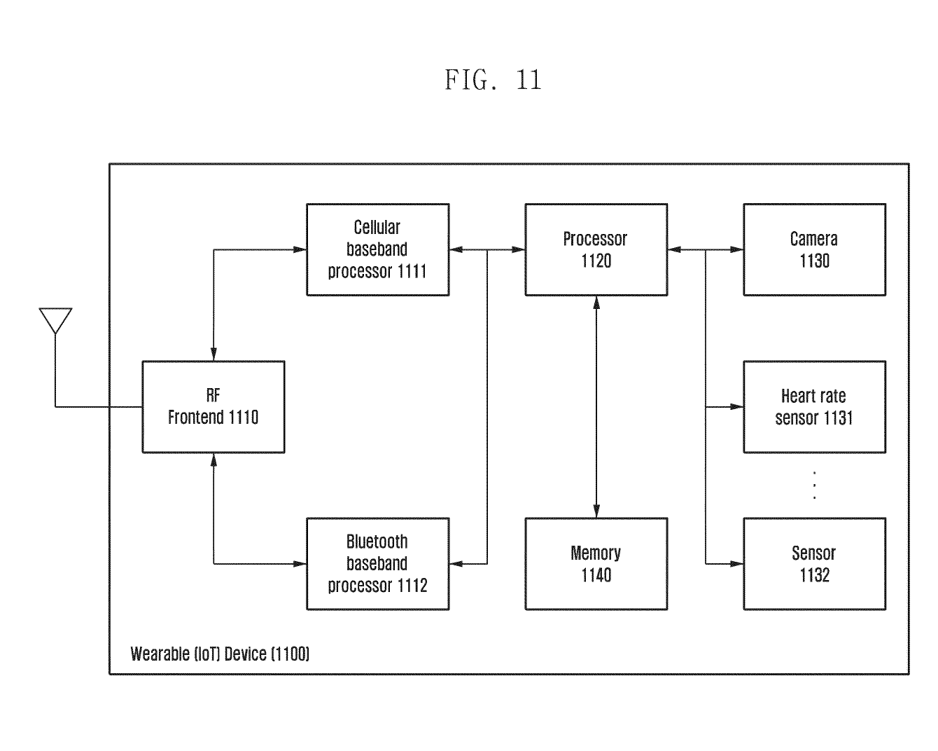

FIG. 11 is a block diagram of a wearable device according to an embodiment of the present disclosure.

Referring to FIG. 11, a wearable device 1100 (e.g., an IoT device) is illustrated, where the wearable device 1100 comprises a radio frequency (RF) front-end 1110, one or more baseband processors 1111, 1112, a processor 1120, a memory 1140 and one or more sensors 1130, 1131, 1132. The RF front-end 1110 and the baseband processors 111, 112 are able to handle multiple wireless technologies including cellular radio, Bluetooth and RF channel (RFC). The processor 1120 is connected with the one or more baseband processors 1111, 1112, the memory 1140, and the one or more sensors 1130, 1131, 1132.

The one or more sensors 1130, 1131, 1132 comprising camera 1130, a heart rate sensor 1131 and other multiple sensors are configured to capture user identity metrics of a user and/or capturing data to detect trigger condition used for alerting of unwanted or fatal situations. The wireless interface comprising the RF front-ends and the one or more baseband processor is configured to perform communication with other electronic device, and to pair/un-pair with/from the other electronic device automatically. The processor configured to control the sensor to capture the user identity metrics, and identify a user based on an association context and the user identity metrics and/or to control sensor to capture data to detect trigger condition used for alerting of unwanted or fatal situation. And the memory 1140 is configured to store the association context.

The processor 1120 is further configured to determine that the user is an authorized user based on a comparison result between the captured user identity metrics and the stored association context, and the processor 1120 is further configured to fetch attributes in the association context from the memory 1140, check a pairing status of the electronic device, if the user is the authorized user. The processor is further configured to determine a first device belongs to the user based on the fetched attributes, if the electronic device is already paired with the first electronic device, and the processor 1120 is further configured to control the one or more wireless interfaces to un-pair from the first device automatically, and pair with an electronic device of the user, if the first device belongs to other user. The processor 1120 is further configured to control to the one or more wireless interfaces to pair with an electronic device of the user automatically, if the IoT device is not paired with any electronic device.

The processor 1120 is further configured to control the one or more wireless interfaces to alert a notification to the authorized user using cellular radio if the user is not the authorized user or to alert some authorized person in the event that the IoT device detects the trigger condition is met about and unwanted or fatal situation.

The processor 1120 is further configured to control the one or more wireless interfaces to un-pair from an electronic device which is already paired with the IoT device, and to scan other electronic device to pair with, if the IoT device is moved a distance greater than a threshold.

The processor 1120 is further configured to store the user identity metrics and/or trigger condition to construct the associated context to the memory 1140.

Various aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), CD-ROMs, magnetic tapes, floppy disks, and optical data storage devices. The non-transitory computer readable recording medium can also be distributed over network coupled computer systems so that the computer readable code is stored and executed in a distributed fashion. Also, functional programs, code, and code segments for accomplishing the present disclosure can be easily construed by programmers skilled in the art to which the present disclosure pertains.

At this point it should be noted that various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device in a wireless communication system, the electronic device comprising:
one or more sensor units electrically coupled with a processor and configured to identify user identity metrics of a user;
a radio frequency (RF) unit electrically coupled with the processor and configured to:
perform a communication with another electronic device, and
pair with the other electronic device or un-pair from the other electronic device;
a memory unit electrically coupled with the processor and configured to store association information; and
the processor configured to:
control the one or more sensor units to identify the user identity metrics,
identify the user based on the association information and the user identity metrics, and
determine that the user is an authorized user based on a result of a comparison between the identified user identity metrics and the stored association information.

2. The electronic device of claim 1, wherein the processor is further configured to, if the user is the authorized user:
fetch attributes of the association information from the memory unit, and
check a pairing status of the electronic device.

3. The electronic device of claim 2, wherein the processor is further configured to determine that a first electronic device belongs to the user based on the fetched attributes, if the electronic device is already paired with the first electronic device.

4. The electronic device of claim 3, wherein the processor is further configured to control the RF unit to, if the first electronic device belongs to another user:
un-pair from the first electronic device, and
pair with a second electronic device of the user.

5. The electronic device of claim 2, wherein the processor is further configured to control to the RF unit to pair with a first electronic device of the user, if the first electronic device is not paired with any electronic device.

6. The electronic device of claim 1, wherein the processor is further configured to control the RF unit to alert a notification to the authorized user using cellular radio, if the user is not the authorized user.

7. The electronic device of claim 1, wherein the processor is further configured to:
control the RF unit to un-pair from a paired electronic device which is already paired with the electronic device, and
scan for another electronic device to pair with, if the electronic device moves a distance that is greater than a threshold.

8. The electronic device of claim 1, wherein the processor is further configured to store, in the memory unit, the user identity metrics to construct the associated information.

9. A method an electronic device for communicating with another electronic device, the method comprising:
capturing user identity metrics of a user; and
determining, by a processor of the electronic device, that the user is an authorized user based on a result of a comparison between the identified user identity metrics and association information.

10. The method of claim 9, further comprising:
fetching attributes of the association information, and
checking a pairing status of the electronic device, if the user is the authorized user.

11. The method of claim 10, further comprising:
determining that a first electronic device belongs to the user based on the fetched attributes, if the electronic device is already paired with the first electronic device.

12. The method of claim 11, further comprising:
un-pairing from the first electronic device, and pairing with a second electronic device of the user, if the first electronic device belongs to another user.

13. The method of claim 10, further comprising:
pairing with a first electronic device of the user, if the first electronic device is not paired with any electronic device.

14. The method of claim 9, further comprising:
alerting a notification to the authorized user using cellular radio, if the user is not the authorized user.

15. The method of claim 9, further comprising:
un-pairing from a paired electronic device which is already paired with the electronic device, and
scanning for another electronic device to pair with, if the electronic device moves a distance that is greater than a threshold.

16. The method of claim 9, further comprising:
storing the user identity metrics to construct the associated information.

17. A non-transitory computer-readable storage medium storing instructions that, when executed, cause at least one processor to perform the method of claim 9.
